(19) United States
(12) Patent Application Publication
(10) Pub. No.: US 2025/0141049 A1
(43) Pub. Date: May 1, 2025

(54) ELASTIC SHEET FOR ALL SOLID-STATE BATTERY AND ALL SOLID-STATE BATTERY INCLUDING SAME

(71) Applicant: SAMSUNG SDI CO., LTD, Yongin-si (KR)

(72) Inventors: Ik Hwan CHO, Yongin-si (KR); Jiwan You, Yongin-si (KR); Changhee Woo, Yongin-si (KR); Jinhwan Park, Yongin-si (KR); Young Gyoon Ryu, Yongin-si (KR)

(21) Appl. No.: 18/670,942

(22) Filed: May 22, 2024

(30) Foreign Application Priority Data
Nov. 1, 2023 (KR) 10-2023-0149240

(51) Int. Cl. H01M 50/486; H01M 50/474

(52) U.S. Cl. CPC H01M 50/486; H01M 50/474

(57) ABSTRACT

An elastic sheet for an all-solid-state battery includes a polyurethane film, a first (meth)acrylate resin layer on a first surface of the polyurethane film, and a second (meth)acrylate resin layer on a second surface of the polyurethane film.

### CROSS-REFERENCE TO RELATED APPLICATION

This application claims priority to and the benefit of Korean Patent Application No. 10-2023-0149240, filed in the Korean Intellectual Property Office on Nov. 1, 2023, the entire contents of which are incorporated herein by reference.

### BACKGROUND

### 1. Field

An elastic sheet for an all-solid-state battery and an all-solid-state battery including the same are disclosed.

### 2. Description of the Related Art

Rechargeable lithium batteries may be recharged and may have three or more times higher energy density per unit weight than conventional batteries, e.g., a lead storage battery, a nickel-cadmium battery, a nickel hydrogen battery, a nickel zinc battery and the like. The rechargeable lithium batteries may be highly charged, and thus, may be commercially manufactured for a laptop, a cell phone, an electric tool, an electric bike, and the like.

### SUMMARY

Aspects of embodiments provide an elastic sheet for an all-solid-state battery including a polyurethane film; a first (meth)acrylate resin layer on one surface of the polyurethane film; and a second (meth)acrylate resin layer on the other surface of the polyurethane film.

The polyurethane film may have a melt index of about 5 g/10 min to about 12 g/10 min measured at a temperature of 210° C. and at 2.16 Kg.

The first (meth)acrylate resin layer and the second (meth)acrylate resin layer may be each in a form of foam.

The elastic sheet may have a value of about 1.4 to about 2, calculated according to Equation 1, tan δₐ/tan δ_{b}, tan δₐ being a loss coefficient (tan δ) when dynamic viscoelasticity is measured at a temperature of 25° C. and a frequency of 100 rad/s, tan δ_{b} being a loss coefficient (tan δ) when dynamic viscoelasticity is measured at a temperature of 25° C. and a frequency of 1 rad/s, and in each of the above conditions, the loss coefficient (tan δ) being calculated as loss modulus/storage modulus.

The elastic sheet may have a tan δₐ value of about 0.7 to about 1.

The elastic sheet may have a tan δ_{b} value of about 0.4 to about 0.7.

The elastic sheet may have a storage modulus of about 0.9 MPa to about 1.5 MPa when dynamic viscoelasticity is measured at a temperature of 25° C. and a frequency of 1 rad/s storage modulus.

The elastic sheet may have a value of about 0.6 to about 1, calculated according to Equation 2, tan δc/tan δₐ, tan δbeing a loss coefficient (tan δ) when dynamic viscoelasticity is measured at a temperature of 45° C. and a frequency of 0.1 rad/s, tan δₐ being a loss coefficient (tan δ) when dynamic viscoelasticity is measured at a temperature of 45° C. and a frequency of 1 rad/s, and in each of the above conditions, the loss coefficient (tan δ) being calculated as loss modulus/storage modulus.

The elastic sheet may have a tan δ_{c} value of about 0.14 to about 0.2.

The elastic sheet may have a tan δₐ value of about 0.2 to about 0.3.

The elastic sheet may have a storage modulus of about 0.4 MPa to about 0.6 MPa, when dynamic viscoelasticity is measured at a temperature of 45° C. and a frequency of 0.1 rad/s.

The elastic sheet may have a compression force deflection that is a compressive strength of 40% to 50% of about 1 MPa to about 5 MPa, measured according to ASTM D3574 at a point where it is compressed to 50% to 60% of its initial thickness.

The elastic sheet may have a stress relief rate of about 11% to about 14% according to Equation 3, where Stress relief rate=100*(Stress after 60 seconds when compressed to 40% of initial thickness)/(Initial stress when compressed to 40% of initial thickness).

The elastic sheet may have a recovery rate of about 65% to about 75% according to Equation 4, where Recovery rate=100*(Stress upon restoration to 60% of an initial thickness after compression to 40% of an initial thickness)/(Initial stress after compression to 60% of an initial thickness).

Aspects of embodiments also provide an all-solid-state battery including the elastic sheet; and an electrode assembly, wherein the electrode assembly includes a positive electrode; a negative electrode; and a solid electrolyte layer between the positive electrode and the negative electrode, wherein the elastic sheet is disposed outside at least one of the positive electrode and the negative electrode.

### BRIEF DESCRIPTION OF THE DRAWINGS

Features will become apparent to those of skill in the art by describing in detail exemplary embodiments with reference to the attached drawings, in which:

FIGS. 1 and 2 are cross-sectional views schematically showing all-solid-state batteries according to some embodiments.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. In addition, it will also be understood that when a layer is referred to as being “between” two layers, it can be the only layer between the two layers, or one or more intervening layers may also be present. Like reference numerals refer to like elements throughout.

As used herein, when specific definition is not otherwise provided, the singular may also include the plural. In addition, unless otherwise specified, “A or B” may mean “including A, including B, or including A and B.”

As used herein, “combination thereof” may mean a mixture of constituents, a laminate, a composite, a copolymer, an alloy, a blend, or a reaction product.

As used herein, (meth)acrylate is a concept that includes acrylate and methacrylate.

As used herein, “weight average molecular weight” is a value measured by gel permeation chromatography (GPC, PL GPC220, Agilent Technologies) and corrected with a cubic function using polystyrene.

As used herein, “thickness” may be measured through a photograph taken with an optical microscope such as a scanning electron microscope, or may be measured using a thickness gauge.

### (Elastic Sheet)

Some embodiments provide an elastic sheet for an all-solid-state battery including a polyurethane film; a first (meth)acrylate resin layer on one surface (e.g., a first surface) of the polyurethane film; and a second (meth)acrylate resin layer on the other surface (e.g., a second surface opposite the first surface) of the polyurethane film.

For example, the elastic sheet may be a three-layered stack of a polyurethane film between two (meth)acrylate resin layers. The elastic sheet according to some embodiments may improve cycle-life characteristics of an all-solid-state battery including the elastic sheet by balancing stress relief characteristics and restoration properties. Hereinafter, an elastic sheet according to some embodiments will be described in detail.

### Polyurethane Film

The polyurethane film contributes to restoration properties of the elastic sheet. The polyurethane film may have (e.g., may exhibit) a melt index (MI) of about 5 g/10 min to about 12 g/10 min measured at a temperature of 210° C. and at 2.16 Kg.

The polyurethane film may have a thickness of about 10 μm to about 100 μm, e.g., about 30 μm to about 80 μm or about 40 to about 60 μm. Within the above range, an excellent polyurethane film may be produced. The polyurethane film may be extruded using thermoplastic polyurethane (TPU) pellets.

### (Meth)Acrylate Resin Layer

The first (meth)acrylate resin layer and the second (meth)acrylate resin layer each contribute to the stress relief characteristics of the elastic sheet.

### (Meth)Acrylate Copolymer

The first (meth)acrylate resin layer and the second (meth)acrylate resin layer may each include a (meth)acrylate copolymer. The (meth)acrylate copolymer is a component that forms the basic skeleton of the first (meth)acrylate resin layer and the second (meth)acrylate resin layer, and is a polymer with excellent stress relief characteristics. Accordingly, the elastic sheet including the (meth)acrylate copolymer may improve cycle-life characteristics of the all-solid-state battery by suppressing breakage of the solid electrolyte during the manufacturing process of the all-solid-state battery or the charging and discharging process of the manufactured all-solid-state battery.

The (meth)acrylate copolymer may be a terpolymer including a first structural unit derived from C1 to C20 linear alkyl (meth)acrylate, a second structural unit derived from C1 to C20 cyclic alkyl (meth)acrylate, and a third structural unit derived from a C1 to C20 alkyl (meth)acrylate including a hydroxy group.

Based on a total amount of the (meth)acrylate copolymer, the first structural unit may be included in an amount of about 30 wt % to about 70 wt %, e.g., about 40 wt % to about 60 wt %; the second structural unit may be included in an amount of about 20 wt % to about 60 wt %, e.g., about 30 to about 50 wt %; and the third structural unit may be included in an amount of about 1 wt % to about 30 wt %, e.g., about 5 wt % to about 15 wt %. Within the above range, the stress relief characteristics of the (meth)acrylate copolymer may be excellently exhibited.

The C1 to C20 linear alkyl (meth)acrylate may be 2-ethylhexyl (meth)acrylate, 2-ethylpentyl (meth)acrylate, 2-ethylheptyl (meth)acrylate, 2-ethylnonyl (meth)acrylate It may be acrylate, 2-propylhexyl (meth)acrylate, 2-propyoctyl (meth)acrylate, or a combination thereof. The C1 to C20 cyclic alkyl (meth)acrylate may be isobornyl (meth)acrylate, cyclohexyl (meth)acrylate, cyclopentyl (meth)acrylate, or a combination thereof. The C1 to C20 alkyl (meth)acrylates including the hydroxy group may be 2-hydroxyethyl (meth)acrylate, 2-hydroxypropyl (meth)acrylate, 3-hydroxypropyl (meth)acrylate, 2-hydroxybutyl (meth)acrylate, 4-hydroxybutyl (meth)acrylate, or a combination thereof.

For example, the (meth)acrylate copolymer may be a copolymer of 2-ethylhexyl (meth)acrylate, isobornyl (meth)acrylate, and 2-hydroxybutyl (meth)acrylate. The (meth)acrylate copolymer may have a weight average molecular weight of about 400,000 to about 2,000,000 g/mol as measured by GPC method.

### Crosslinking Agent

The first (meth)acrylate resin layer and the second (meth)acrylate resin layer may each further include a crosslinking agent. The crosslinking agent forms a network-structured polymer through intermolecular and/or intramolecular chemical bonds of the (meth)acrylate copolymer. Accordingly, if the first (meth)acrylate resin layer and the second (meth)acrylate resin layer each further include a crosslinking agent, mechanical properties may be improved.

The crosslinking agent may be an isocyanate crosslinking agent. For example, the crosslinking agent may be a trimethylolpropane/xylylene diisocyanate adduct.

Based on 100 parts by weight of the (meth)acrylate copolymer, the crosslinking agent may be included in an amount of about 0.01 to about 1 part by weight, e.g., about 0.05 to about 0.5 parts by weight or about 0.1 to about 0.3 parts by weight. Within the above range, the mechanical properties of the elastic sheet may be improved.

### Inorganic Particles

The first (meth)acrylate resin layer and the second (meth)acrylate resin layer may each further include inorganic particles. If the first (meth)acrylate resin layer and the second (meth)acrylate resin layer each further include inorganic particles, compressive strength may be improved.

The inorganic particles may be silica, boehmite, alumina, or a combination thereof. For example, the inorganic particle may be silica.

The inorganic particle may have a sphere shape, and in this case, D50 may be about 100 to about 500 nm.

Based on 100 parts by weight of the (meth)acrylate copolymer, the inorganic particles may be included in an amount of about 0.01 to about 1 part by weight, e.g., about 0.1 to about 0.5 parts by weight. Within the above range, the compressive strength of the elastic sheet may be improved.

### Pore-Forming Agent

The first (meth)acrylate resin layer and the second (meth)acrylate resin layer may each be in the form of foam. In this case, the first (meth)acrylate resin layer and the second (meth)acrylate resin layer may each include a pore-forming agent.

On the other hand, when the first (meth)acrylate resin layer and the second (meth)acrylate resin layer do not include the pore-forming agent, they may be in the form of a dense layer with no pores formed therein.

If the first (meth)acrylate resin layer and the second (meth)acrylate resin layer are each in the form of a foam, a density of the foam may be about 0.35 g/cm² to about 0.8 g/cm². If the density of the foam exceeds the above range, it may come out flat during compression or the compressive strength may become excessively high. On the other hand, if the density of the foam is less than the above range, the pores constituting the foam may be connected to each other during the charging and discharging process of the all-solid-state battery, thereby reducing the stability.

If the first (meth)acrylate resin layer and the second (meth)acrylate resin layer are each in the form of a dense layer rather than a foam, deformation or fracture of the solid electrolyte may occur due to high compressive strength. Accordingly, it is desirable that the first (meth)acrylate resin layer and the second (meth)acrylate resin layer are each in the form of foam, and in this case, excellent stress relief characteristics may be exhibited.

The pore-forming agent may be an inorganic pore-forming agent, an organic pore-forming agent, or a combination thereof.

As used herein, the term “hollow” refers to a hollow shape (e.g., a cavity or a shape with a cavity).

The inorganic pore-forming agent may be glass microspheres. For example, the glass microspheres may be glass bubbles. The glass bubble may be a hollow particle made of glass.

The organic pore-forming agent may be a thermally expandable polymer microsphere. The thermally expandable polymer microsphere may have a form of a capsule having a hollow and a shell, and a liquid having a boiling point below the softening temperature of the shell may be included in the hollow for foaming.

The liquid included in the hollow of the thermally expandable polymer microsphere may include hydrocarbons, e.g., n-butane, isobutane, n-pentane, neopentane, isopentane, hexane, isohexane, heptane, octane, cyclopentane, cyclopentene, 1-pentene, and 1-hexene. For example, the hydrocarbons may have a boiling point of less than 60° C. at atmospheric pressure. For example, the liquid included in the hollow may be isobutane.

The shell of the thermally expandable polymer microsphere may include an acrylic copolymer, e.g., an acrylonitrile copolymer.

The thermally expandable polymer microsphere may be in a form of a general powder at room temperature, but when exposed to high temperatures, the liquid included in the hollow of the thermally expandable polymer microsphere may vaporize and expand the capsule, so that it may be applied as a foaming agent. The thermally expandable polymer microsphere may expand at about 150° C. to about 200° C., expanding its volume by about 50 times to about 100 times its initial size.

Based on 100 parts by weight of the (meth)acrylate copolymer, the pore-forming agent may be included in an amount of about 0.1 to about 5 parts by weight, e.g., about 1 to about 2 parts by weight. Within the above range, pores may be formed within an appropriate range within each of the first (meth)acrylate resin layer and the second (meth)acrylate resin layer.

### Physical Properties of Elastic Sheet

The elastic sheet may balance stress relief characteristics and restoration properties and thus have a loss coefficient (tan δ) within an appropriate range. Herein, the loss coefficient (tan δ) is calculated as a ratio of a loss modulus/a storage modulus, wherein a decrease in loss coefficient, increases elasticity strength, and an increase in loss coefficient, increases viscosity strength.

The loss modulus and the storage modulus may be obtained by using a dynamic mechanical analyzer (DMA). For example, after preparing the elastic sheet into a specimen with a predetermined size, the specimen may be placed between two jigs, and then fixed by applying a force to the two jigs. Herein, a distance between the two jigs may be about 10 mm to about 20 mm, e.g., about 11 mm to about 15 mm or about 11 mm to about 13 mm.

The elastic sheet fixed between the two jigs, of which a temperature is changed, while simultaneously applying stain thereto, may be measured with respect to dynamic viscoelasticity under the conditions of a specific temperature and a specific frequency. Herein, the loss modulus and the storage modulus are evaluated, which are used to calculate the ratio of the loss modulus/the storage modulus to obtain the loss coefficient (tan δ).

The elastic sheet has a loss coefficient (tan δ) within an appropriate range, and therefore, may harmoniously exhibit stress relief characteristics and restoration properties which are in a trade-off relationship.

In general, at about 25° C. (i.e., a temperature at which all-solid-state batteries are manufactured), unexpected impacts (e.g., external impacts) may occur during the assembly and/or pressurization process. Herein, if the elastic sheet has a high loss coefficient (tan δ), the elastic sheet may absorb and disperse the external impacts, resultantly protecting the all-solid-state battery.

The elastic sheet may have a value of about 1.4 to about 2, e.g., about 1.45 to about 1.8 or about 1.45 to about 1.7, calculated according to Equation 1:

$$tan {δ}_{a} / tan {δ}_{b} \qquad [ Equation 1 ]$$

wherein, in Equation 1, tan δₐ is a loss coefficient (tan δ) when dynamic viscoelasticity is measured at a temperature of 25° C. and a frequency of 100 rad/s, and tan δ_{b} is a loss coefficient (tan δ) when dynamic viscoelasticity is measured at a temperature of 25° C. and a frequency of 1 rad/s. In each of the above conditions, the loss coefficient (tan δ) is calculated as loss modulus/storage modulus.

The elastic sheet may have a tan δₐ value of about 0.7 to about 1, e.g., about 0.7 to about 0.9. The elastic sheet may have a tan δ_{b} value of about 0.4 to about 0.7, e.g., about 0.4 to about 0.6.

The elastic sheet may have a storage modulus of about 0.9 MPa to about 1.5 MPa, e.g., about 1 to about 1.2 MPa, when dynamic viscoelasticity is measured at a temperature of 25° C. and a frequency of 1 rad/s.

On the other hand, at 45° C. when the all-solid-state battery is charged and discharged, a volume of electrodes may be changed. Herein, the elastic sheet, if it has a low loss coefficient (tan δ), has strong restoration properties to return to its original position and thus may maintain a close-contacting force of each layer constituting the all-solid-state battery.

The elastic sheet may have a value of about 0.6 to about 1, e.g., about 0.6 to about 0.9, calculated according to Equation 2:

$$tan {δ}_{c} / tan {δ}_{d} \qquad [ Equation 2 ]$$

wherein, in Equation 2, tan δc is a loss coefficient (tan δ) when dynamic viscoelasticity is measured at a temperature of 45° C. and a frequency of 0.1 rad/s, and tan δₐ is a loss coefficient (tan δ) when dynamic viscoelasticity is measured at a temperature of 45° C. and a frequency of 1 rad/s. In each of the above conditions, the loss coefficient (tan δ) is calculated as loss modulus/storage modulus.

The elastic sheet may have a tan δc value of about 0.14 to about 0.2, e.g., about 0.14 to about 0.19. The elastic sheet may have a tan δₐ value of about 0.2 to about 0.3, e.g., about 0.2 to about 0.26.

The storage modulus may be about 0.4 MPa to about 0.6 MPa, e.g., about 0.4 to about 0.5 MPa, when dynamic viscoelasticity is measured at a temperature of 45° C. and a frequency of 0.1 rad/s.

Hereinafter, CFD (Compression Force Deflection) n % means the compressive strength measured according to ASTM D3574 at the point compressed to become (100−n) % of the initial thickness. The elastic sheet may have CFD that is a compressive strength of 40% to 50% of about 1 MPa to about 5 MPa, e.g., about 1 MPa to about 3 MPa, measured according to ASTM D3574 at the point where it is compressed to 50% to 60% of its initial thickness.

Examples of measurement of CFD (Compression Force Deflection) n % are as follows.

The elastic sheet is manufactured into a specimen with dimensions of width*length=2 cm*2 cm, and compression is performed at a compression rate of 0.6 mm/min (10 μm/sec) using a compression tester with a spherical jig with a diameter of 10 mm. For elastic sheet specimens, CFD n % is measured using UTM (manufacturer: Shimadzu Scientific Korea Corp.) according to ASTM D3574 at the point in time when compressed to (100−n) % of the initial thickness after pressing.

The elastic sheet may have a stress relief rate of about 11% to about 14% according to Equation 3:

$$Stress relief rate = 100 * ( Stress after 60 seconds when compressed to 40 \% of initial thickness ) / ( Initial stress when compressed to 40 \% of initial thickness ) \qquad [ Equation 3 ]$$

Examples of measurement of stress relief rate are as follows.

The elastic sheet is manufactured into a specimen with dimensions of width*length=2 cm*2 cm, and compression is performed at a compression rate of 0.6 mm/min (10 μm/sec) using a compression tester with a spherical jig with a diameter of 10 mm. The elastic sheet specimen is measured with respect to initial stress at a point of being compressed to 40% of its initial thickness. In addition, after 60 seconds from the point of being compressed to 40% of its initial thickness, stress of the elastic sheet specimen is measured. Herein, the stress at each point is measured by using TA (Texture Analyzer, Manufacturer: Stable Micro Systems). The stress measurements at each point are inserted into Equation 3 to obtain a stress relief rate.

The elastic sheet may have a recovery rate of about 65% to about 75% according to Equation 4:

$$Recovery rate = 100 * ( Stress upon restoration to 60 \% of the initial thickness after compression to 40 \% of the initial thickness ) / ( Initial stress after compression to 60 \% of the initial thickness ) \qquad [ Equation 4 ]$$

Examples of measurement of the recovery rate are as follows.

The elastic sheet is manufactured into a specimen with dimensions of width*length=2 cm*2 cm, and compression is performed at a compression rate of 0.6 mm/min (10 μm/sec) using a compression tester with a spherical jig with a diameter of 10 mm. The elastic sheet specimen is measured with respect to initial stress at a point of being compressed to 60% of its initial thickness. In addition, at a point of being recovered to 60% of its initial thickness after being compressed to 40% of its initial thickness, stress of the elastic sheet specimen is measured. Herein, the stress at each point is measured by using TA (Texture Analyzer, Manufacturer: Stable Micro Systems). The stress measurements at each point are inserted into Equation 4 to obtain a recovery rate.

### Thickness of Elastic Sheet

A total thickness of the elastic sheet may be about 100 μm to about 800 μm, e.g., about 100 μm to about 600 μm or about 150 μm to about 500 μm. Within this thickness range, the elastic sheet may sufficiently relieve stress due to pressure and stress due to thickness changes during charging and discharging and may exhibit excellent restoring force. The thickness of the elastic sheet may be measured using a thickness gauge.

### Structure of Elastic Sheet

The elastic sheet may further include a protective film or coating layer on one surface.

### (All-Solid-State Battery)

In some embodiments, an all-solid-state battery may include the elastic sheet, and an electrode assembly. The electrode assembly may include a positive electrode, a negative electrode, and a solid electrolyte layer between the positive electrode and the negative electrode, and the elastic sheet may be disposed outside at least one of the positive electrode and the negative electrode.

The elastic sheet may be disposed on the outermost layer of the electrode assembly, or, in a structure in which two or more electrode assemblies are stacked, may be disposed on the outermost layer and/or inside the electrode assembly. Considering that the thickness of the negative electrode changes significantly during charging and discharging due to dendrite formation, etc., the elastic sheet may play a role in buffering changes in thickness by being disposed on the outside of the negative electrode, i.e., on the opposite surface of the surface where the solid electrolyte layer is in contact with the negative electrode. In addition, the elastic sheet may prevent deterioration by reacting with lithium by being disposed on the outside of the positive electrode and/or negative electrode, thereby increasing the coulombic efficiency of the battery.

Hereinafter, an all-solid-state battery according to some embodiments will be described in detail. The all-solid-state battery may also be expressed as an all-solid-state rechargeable battery or an all-solid-state rechargeable lithium battery.

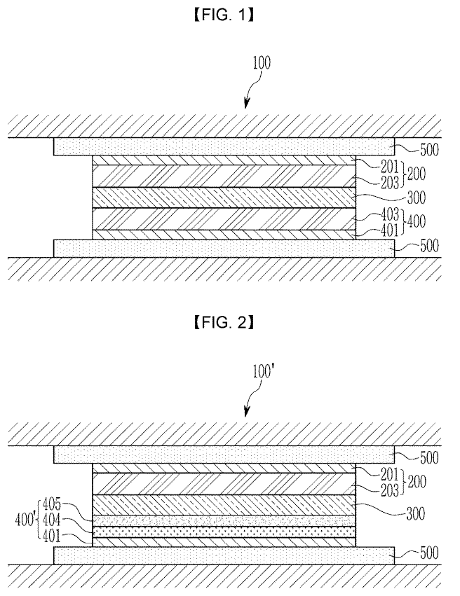

FIG. 1 is a cross-sectional view of an all-solid-state battery according to some embodiments. Referring to FIG. 1, an all-solid-state battery 100 may include an electrode assembly having a negative electrode 400 including a negative current collector 401 and a negative electrode active material layer 403, a solid electrolyte layer 300, and a positive electrode 200 including a positive electrode active material layer 203 and a positive current collector 201 that are stacked. The electrode assembly may be inserted into a case, e.g., a pouch. The all-solid-state battery 100 may further include at least one elastic sheet 500 on the outside of at least either one of the positive electrode 200 and the negative electrode 400. FIG. 1 shows one electrode assembly including the negative electrode 400, the solid electrolyte layer 300, and the positive electrode 200, but two or more electrode assemblies may be stacked to manufacture an all-solid-state battery.

An all-solid-state battery according to some embodiments may be manufactured by preparing a laminate by sequentially stacking a positive electrode, a solid electrolyte, and a negative electrode, and pressing the laminate. The pressing may be performed at a temperature of, e.g., about 25° C. to about 90° C., and may be performed at a pressure of less than or equal to about 550 MPa, e.g., less than or equal to about 500 MPa or about 400 MPa to about 500 MPa. The pressing may be, e.g., isostatic press, roll press or plate press.

The all-solid-state battery may be a unit cell having a structure of a positive electrode/solid electrolyte layer/negative electrode, a bicell having a structure of positive electrode/solid electrolyte layer/negative electrode/solid electrolyte layer/positive electrode, or a stacked battery in which the structure of the unit cell is repeated.

The shape of the all-solid-state battery may be, e.g., a coin type, a button type, a sheet type, a stack type, a cylindrical shape, a flat type, and the like. Additionally, the all-solid-state battery may also be applied to medium to large-sized batteries used in electric vehicles, etc. For example, the all-solid-state battery may also be used in a hybrid vehicle such as a plug-in hybrid electric vehicle (PHEV). In addition, it may be applied to an energy storage system (ESS) that requires large amounts of power storage, and may also be applied to electric bicycles or power tools.

### Positive Electrode Active Material

The positive electrode active material may be a compound capable of reversible intercalation and deintercalation of lithium (lithiated intercalation compound). For example, one or more types of complex oxides of lithium and a metal selected from cobalt, manganese, nickel, and a combination thereof may be used.

The complex oxide may be a lithium transition metal complex oxide, and specific examples include a lithium nickel oxide, a lithium cobalt oxide, a lithium manganese oxide, a lithium iron phosphate compound, a cobalt-free lithium nickel-manganese oxide, or a combination thereof.

For example, a compound represented by any of the chemical formulas may be used. LiₐA_{1-b}X_{b}O_{2-c}D′_{c} (0.90≤a≤1.8, 0≤b≤0.5, 0≤c≤0.05); LiₐMn_{2-b}X_{b}O_{4-c}D′_{c} (0.90≤a≤1.8, 0≤b≤0.5, 0≤c≤0.05); LiₐNi_{1-b-c}Co_{b}X_{c}O_{2-α}D′_{α} (0.90≤a≤1.8, 0≤b≤0.5, 0≤c≤0.5, 0≤α≤2); LiₐNi_{1-b-c}Mn_{b}X_{c}O_{2-α}D′_{α} (0.90≤a≤1.8, 0≤b≤0.5, 0≤c≤0.5, 0<α<2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); and LiₐFePO₄ (0.90≤a≤1.8).

In the above chemical formulas, A is Ni, Co, Mn, or a combination thereof; X is Al, Ni, Co, Mn, Cr, Fe, Mg, Sr, V, rare earth element, or a combination thereof; D′ is O, F, S, P, or a combination thereof; G is Al, Cr, Mn, Fe, Mg, La, Ce, Sr, V, or a combination thereof; and L¹ is Mn, Al, or a combination thereof.

For example, the positive electrode active material may be a high nickel positive electrode active material that has a nickel content of greater than or equal to 80 mol %, greater than or equal to 85 mol %, greater than or equal to 90 mol %, greater than or equal to 91 mol %, or greater than or equal to 94 mol % and less than or equal to 99 mol % based on 100 mol % of metals excluding lithium in the lithium transition metal complex oxide. The high-nickel positive electrode active materials may achieve high capacity and may be applied to high-capacity, high-energy-density lithium rechargeable batteries.

The positive electrode active material may include, e.g., lithium nickel oxide represented by Chemical Formula 11, lithium cobalt oxide represented by Chemical Formula 12, a lithium iron phosphate compound represented by Chemical Formula 13, and cobalt-free lithium nickel manganese oxide represented by Chemical Formula 14, or a combination thereof.

Liₐ₁Niₓ₁M¹_{y1}M²_{z1}O_{2-b1}X_{b1} [Chemical Formula 11]

In Chemical Formula 11, 0.9≤a1≤1.8, 0.3≤x1≤1, 0≤y1≤0.7, 0≤z1≤0.7, 0.9≤x1+y1+z1≤1.1, and 0≤b1≤0.1 (e.g., 0.6≤x1≤1, 0≤y1≤0.4, and 0≤z1≤0.4, or 0.8≤x1≤1, 0≤y1≤0.2, and 0≤z1≤0.2), M¹ and M² are each independently one or more elements selected from Al, B, Ba, Ca, Ce, Co, Cr, Cu, Fe, Mg, Mn, Mo, Nb, Si, Sn, Sr, Ti, V, W, and Zr, and X is one or more elements selected from F, P, and S.

Liₐ₂Coₓ₂M³_{y2}O_{2-b2}X_{b2} [Chemical Formula 12]

In Chemical Formula 12, 0.9≤a2≤1.8, 0.7≤x2≤1, 0≤y2≤0.3, 0.9≤x2+y2≤1.1, and 0≤b2≤0.1, M³ is one or more elements selected from Al, B, Ba, Ca, Ce, Cr, Cu, Fe, Mg, Mn, Mo, Ni, Se, Si, Sn, Sr, Ti, V, W, Y, Zn, and Zr, and X is one or more elements selected from F, P, and S.

Liₐ₃Feₓ₃M⁴_{y3}PO_{4-b3}X_{b3} [Chemical Formula 13]

In Chemical Formula 13, 0.9≤a3≤1.8, 0.63x3≤1, 0≤y3≤0.4, and 0≤b3≤0.1, M⁴ is one or more elements selected from Al, B, Ba, Ca, Ce, Co, Cr, Cu, Mg, Mn, Mo, Ni, Se, Si, Sn, Sr, Ti, V, W, Y, Zn, and Zr, and X is one or more elements selected from F, P, and S.

Liₐ₄Niₓ₄Mn_{y4}M⁵_{z4}O_{2-b4}X_{b4} [Chemical Formula 14]

In Chemical Formula 14, 0.9≤a2≤1.8, 0.8≤x4<1, 0<y4≤0.2, 0≤z4≤0.2, 0.9≤x4+y4+z4≤1.1, and 0≤b4≤0.1, M⁵ is one or more elements selected from Al, B, Ba, Ca, Ce, Cr, Fe, Mg, Mo, Nb, Si, Sn, Sr, Ti, V, W, and Zr, and X is one or more elements selected from F, P, and S.

The average particle diameter (D50) of the positive electrode active material may be about 1 μm to about 25 μm, e.g., about 3 μm to about 25 μm, about 1 μm to about 20 μm, about 1 μm to about 18 μm, about 3 μm to about 15 μm, or about 5 μm to about 15 μm. As an example, the positive electrode active material may include small particles having an average particle diameter (D50) of about 1 μm to about 9 μm and large particles having an average particle diameter (D50) of about 10 μm to about 25 μm. The positive electrode active material having this particle size range may be harmoniously mixed with other components within the positive electrode active material layer and may achieve high capacity and high energy density. Herein, the average particle diameter may be obtained by selecting about 20 particles at random in the scanning electron microscope image of the positive electrode active material, measuring the particle diameter (e.g., diameter, long axis, or length of the long axis) to obtain the particle size distribution, and taking the diameter (D50) of particles with a cumulative volume of 50 volume % as the average particle diameter in the particle size distribution.

The positive electrode active material may be in the form of secondary particles made by agglomerating a plurality of primary particles, or may be in the form of single particles. Additionally, the positive electrode active material may have a spherical or close to spherical shape, or may have a polyhedral or irregular shape.

Meanwhile, the positive electrode active material may include a buffer layer on the particle surface. The buffer layer may be expressed as a coating layer, a protective layer, etc., and may play a role in lowering the interfacial resistance between the positive electrode active material and the sulfide solid electrolyte particles. As an example, the buffer layer may include lithium-metal-oxide, wherein the metal may be, e.g., one or more elements selected from Al, B, Ca, Ce, Cr, Fe, Mg, Mo, Nb, Si, Sn, Sr, Ta, V, W, and Zr. The lithium-metal-oxide is excellent for improving the performance of the positive electrode active material by facilitating the movement of lithium ions and electronic conduction, while lowering the interfacial resistance between the positive electrode active material and solid electrolyte particles.

### Positive Electrode

A positive electrode for an all-solid-state battery may include a current collector and a positive electrode active material layer on the current collector, and the positive electrode active material layer may include a positive electrode active material and may optionally include a solid electrolyte, a binder, and/or a conductive material. For example, the positive electrode may further include an additive that may function as a sacrificial positive electrode.

A content of the positive electrode active material may be about 90 wt % to about 99.5 wt % based on 100 wt % of the positive electrode active material layer and each content of the binder and the conductive material may be about 0.5 wt % to about 5 wt % based on 100 wt % of the positive electrode active material layer.

The binder improves binding properties of positive electrode active material particles with one another and with the current collector. Examples of the binder may include polyvinyl alcohol, carboxymethyl cellulose, hydroxypropyl cellulose, diacetyl cellulose, polyvinyl chloride, carboxylated polyvinyl chloride, polyvinyl fluoride, an ethylene oxide-containing polymer, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, and nylon, but are not limited thereto.

The conductive material is included to provide electrode conductivity and any electrically conductive material may be used as a conductive material unless it causes a chemical change. Examples of the conductive material may include a carbon material, e.g., natural graphite, artificial graphite, carbon black, acetylene black, ketjen black, a carbon fiber, a carbon nanofiber, a carbon nanotube, and the like; a metal material of a metal powder or a metal fiber including copper, nickel, aluminum, silver, and the like; a conductive polymer, e.g., a polyphenylene derivative; or a mixture thereof.

The positive electrode active material layer may optionally further include a solid electrolyte. The solid electrolyte may include, e.g., a sulfide solid electrolyte, an oxide solid electrolyte, a halide solid electrolyte, or a combination thereof, and detailed descriptions thereof will be provided later in the solid electrolyte layer section.

Based on 100 wt % of the positive electrode active material layer, the solid electrolyte may be included in an amount of about 0.1 wt % to about 35 wt %, e.g., about 1 wt % to about 35 wt %, about 5 wt % to about 30 wt %, about 8 wt % to about 25 wt %, or about 10 wt % to about 20 wt %.

In the positive electrode active material layer, based on a total of 100 wt % of the positive electrode active material and the solid electrolyte, about 65 wt % to about 99 wt % of the positive electrode active material and about 1 wt % to about 35 wt % of the solid electrolyte may be included, e.g., about 80 wt % to about 90 wt % of the positive electrode active material and about 10 wt % to about 20 wt % of the solid electrolyte. If the solid electrolyte is included in the positive electrode within the amount ranges, the efficiency and cycle-life characteristics of the all-solid-state secondary battery may be improved without reducing the capacity.

The current collector may include Al.

### Negative Electrode Active Material

The negative electrode active material may include a material that reversibly intercalates/deintercalates lithium ions, a lithium metal, a lithium metal alloy, a material capable of doping/dedoping lithium, or transition metal oxide.

The material that reversibly intercalates/deintercalates lithium ions may include, e.g., crystalline carbon, amorphous carbon, or a combination thereof as a carbon negative electrode active material. The crystalline carbon may be irregular, or sheet, flake, spherical, or fiber shaped natural graphite or artificial graphite. The amorphous carbon may be a soft carbon, a hard carbon, a mesophase pitch carbonization product, calcined coke, and the like.

The lithium metal alloy may include an alloy of lithium and a metal selected from Na, K, Rb, Cs, Fr, Be, Mg, Ca, Sr, Si, Sb, Pb, In, Zn, Ba, Ra, Ge, Al, and Sn.

The material capable of doping/dedoping lithium may be a Si negative electrode active material or a Sn negative electrode active material. The Si negative electrode active material may include silicon, a silicon-carbon composite, SiOₓ (0<x<2), a Si-Q alloy (wherein Q is an element selected from an alkali metal, an alkaline-earth metal, a Group 13 element, a Group 14 element (excluding Si), a Group 15 element, a Group 16 element, a transition metal, a rare earth element, and a combination thereof), or a combination thereof. The Sn negative electrode active material may be Sn, SnO₂, a Sn alloy, or a combination thereof.

The silicon-carbon composite may be a composite of silicon and amorphous carbon. According to some embodiments, the silicon-carbon composite may be in the form of silicon particles and amorphous carbon coated on the surface of the silicon particles. For example, it may include a secondary particle (core) in which silicon primary particles are assembled and an amorphous carbon coating layer (shell) on the surface of the secondary particle. The amorphous carbon may also be present between the silicon primary particles, e.g., the silicon primary particles may be coated with amorphous carbon. The secondary particles may exist dispersed in an amorphous carbon matrix.

The silicon-carbon composite may further include crystalline carbon. For example, the silicon-carbon composite may include a core including crystalline carbon and silicon particles and an amorphous carbon coating layer on the surface of the core.

The Si negative electrode active material or Sn negative electrode active material may be mixed with the carbon negative electrode active material.

### Negative Electrode

For example, a negative electrode for an all-solid-state battery may include a current collector and a negative electrode active material layer on the current collector. The negative electrode active material layer includes a negative electrode active material and may further include a binder, a conductive material, and/or a solid electrolyte.

For example, the negative electrode active material layer may include about 90 wt % to about 99 wt % of the negative electrode active material, about 0.5 wt % to about 5 wt % of the binder, and about 0 wt % to about 5 wt % of the conductive material.

The binder serves to adhere the negative electrode active material particles to each other and also to adhere the negative electrode active material to the current collector. The binder may be a non-aqueous binder, an aqueous binder, a dry binder, or a combination thereof.

The non-aqueous binder may include polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, polyamideimide, polyimide, or a combination thereof.

The aqueous binder may include a styrene-butadiene rubber, a (meth)acrylated styrene-butadiene rubber, a (meth)acrylonitrile-butadiene rubber, a (meth)acrylic rubber, butyl rubber, a fluorine rubber, polyethylene oxide, polyvinylpyrrolidone, polyepichlorohydrin, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resin, polyvinyl alcohol, or a combination thereof.

When an aqueous binder is used as the negative electrode binder, a cellulose compound capable of imparting viscosity may be further included. As the cellulose compound, one or more of carboxymethyl cellulose, hydroxypropylmethyl cellulose, methyl cellulose, or alkali metal salts thereof may be mixed and used. The alkali metal may be Na, K, or Li.

The dry binder may be a polymer material capable of becoming fiber, and may be, e.g., polytetrafluoroethylene, polyvinylidene fluoride, a polyvinylidene fluoride-hexafluoropropylene copolymer, polyethylene oxide, or a combination thereof.

The conductive material is included to provide electrode conductivity and any electrically conductive material may be used as a conductive material unless it causes a chemical change. Examples of the conductive material include a carbon material, e.g., natural graphite, artificial graphite, carbon black, acetylene black, ketjen black, a carbon fiber, a carbon nanofiber, a carbon nanotube, and the like; a metal material of a metal powder or a metal fiber including copper, nickel, aluminum silver, and the like; a conductive polymer, e.g., a polyphenylene derivative; or a mixture thereof.

The negative electrode current collector may include, e.g., a copper foil, a nickel foil, a stainless steel foil, a titanium foil, a nickel foam, a copper foam, a polymer substrate coated with a conductive metal, or a combination thereof.

### Precipitation-Type Negative Electrode

Meanwhile, as an example, the negative electrode for an all-solid-state battery may be a precipitation-type negative electrode. The precipitation-type negative electrode does not include a negative electrode active material during battery assembly, but refers to a negative electrode in which lithium metal, etc. is precipitated during battery charging, thereby serving as a negative electrode active material.

FIG. 2 is a schematic cross-sectional view of an all-solid-state battery 100′ including a precipitation-type negative electrode. Referring to FIG. 2, a precipitation-type negative electrode 400′ may include the current collector 401 and a negative electrode coating layer 405 on the current collector. In an all-solid-state battery having such a precipitation-type negative electrode 400′, initial charging begins in the absence of negative electrode active material, and during charging, high-density lithium metal is precipitated between the current collector 401 and the negative electrode coating layer 405 to form a lithium metal layer 404, which may serve as a negative electrode active material. Accordingly, in an all-solid-state battery that has been charged at least once, the precipitation-type negative electrode 400′ may include the current collector 401, the lithium metal layer 404 on the current collector 401, and the negative electrode coating layer 405 on the metal layer 404. The lithium metal layer 404 may be referred to as a layer in which lithium metal, etc. is precipitated during the charging process of the battery, and may be referred to as a metal layer or negative electrode active material layer.

The negative electrode coating layer 405 may include metal and/or carbon material that acts as a catalyst.

The metal may be a lithiophilic metal and may include, e.g., gold, platinum, palladium, silicon, silver, aluminum, bismuth, tin, zinc, or a combination thereof, and may be composed of one of these or various types of alloys. An average particle diameter (D50) of the metal may be less than or equal to about 4 μm, e.g., about 10 nm to about 4 μm, about 10 nm to about 2 μm, or about 10 nm to about 1 μm.

The carbon material may be, e.g., crystalline carbon, non-graphitic carbon, or a combination thereof. For example, the crystalline carbon may be at least one selected from natural graphite, artificial graphite, mesophase carbon microbeads, and a combination thereof. The non-graphitic carbon may be at least one selected from carbon black, activated carbon, acetylene black, denka black, ketjen black, furnace black, graphene, and a combination thereof.

When the negative electrode coating layer 405 includes both the metal and the carbon material, a mixing ratio of the metal and the carbon material may be, e.g., a weight ratio of about 1:10 to about 2:1, about 1:10 to about 2:1, about 5:1 to about 1:1, or about 4:1 to about 2:1. In this case, precipitation of lithium metal may be effectively promoted and the characteristics of the all-solid-state battery may be improved. For example, the negative electrode coating layer 405 may include a carbon material on which a catalyst metal is supported, or may include a mixture of metal particles and carbon material particles.

The negative electrode coating layer 405 may further include a binder, and the binder may be, e.g., a conductive binder. Additionally, the negative electrode coating layer 405 may further include general additives, e.g., a dispersant, an ion conductive material, and the like.

A thickness of the negative electrode coating layer 405 may be, e.g., about 1 μm to about 20 μm, about 2 μm to about 10 μm, or about 3 μm to about 7 μm. Additionally, the thickness of the negative electrode coating layer 405 may be about 50% or less, about 20% or less, or about 5% or less of the thickness of the positive electrode active material layer. If the thickness of the negative electrode coating layer 405 is too thin, it may be collapsed by the lithium metal layer 404, and if the thickness is too thick, the density of the all-solid-state battery may decrease and internal resistance may increase.

The precipitation-type negative electrode 400′ may further include a thin film, e.g., on the surface of the current collector, i.e., between the current collector and the negative electrode catalyst layer. The thin film may include an element capable of forming an alloy with lithium. The element capable of forming an alloy with lithium may be, e.g., gold, silver, zinc, tin, indium, silicon, aluminum, bismuth, and the like, which may be used alone or an alloy of more than one. The thin film may further planarize a precipitation shape of the lithium metal layer 404 and much improve characteristics of the all-solid-state battery. The thin film may be formed, e.g., in a vacuum deposition method, a sputtering method, a plating method, and the like. The thin film may have, e.g., a thickness of about 1 nm to about 800 nm, or about 100 nm to about 500 nm.

The lithium metal layer 404 may include a lithium metal or a lithium alloy. The lithium alloy may be, e.g., a Li—Al alloy, a Li—Sn alloy, a Li—In alloy, a Li—Ag alloy, a Li—Au alloy, a Li—Zn alloy, a Li—Ge alloy, or a Li—Si alloy.

A thickness of the lithium metal layer 404 may be about 1 μm to about 500 μm, about 1 μm to about 200 μm, about 1 μm to about 100 μm, or about 1 μm to about 50 μm. If the thickness of the lithium metal layer 404 is too thin, it may be difficult to perform the role of a lithium storage, and if it is too thick, the battery volume may increase and performance may deteriorate.

When applying such a precipitation-type negative electrode, the negative electrode coating layer 405 may serve to protect the lithium metal layer 404 and suppress the precipitation growth of lithium dendrite. Accordingly, short circuit and capacity degradation of the all-solid-state battery may be suppressed and cycle-life characteristics may be improved.

### Solid Electrolyte Layer

The solid electrolyte layer includes a solid electrolyte. The solid electrolyte may be a type of inorganic solid electrolyte, and may include, e.g., a sulfide solid electrolyte, an oxide solid electrolyte, a halide solid electrolyte, or a combination thereof.

### Sulfide Solid Electrolyte

The sulfide solid electrolyte may include, e.g., Li₂S—P₂S₅, Li₂S—P₂S₅—LiX (wherein X is a halogen element, for example I or Cl), Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (wherein m and n are an integer, respectively, and Z is Ge, Zn, or Ga), Li₂S—GeS₂, Li₂S—SiS₂—Li₃PO₄, Li₂S—SiS₂-LiₚMO_{q} (wherein p and q are integers, and M is P, Si, Ge, B, Al, Ga, or In), or a combination thereof.

Such a sulfide solid electrolyte may be obtained by, e.g., mixing Li₂S and P₂S₅ in a molar ratio of about 50:50 to about 90:10 or about 50:50 to about 80:20 and optionally, performing heat-treatment. Within the above mixing ratio range, a sulfide solid electrolyte having excellent ionic conductivity may be prepared. The ionic conductivity may be further improved by adding SiS₂, GeS₂, B₂S₃, and the like as other components thereto.

Mechanical milling or a solution method may be applied as a mixing method of sulfur-containing raw materials for preparing a sulfide solid electrolyte. The mechanical milling is to make starting materials into particulates by putting the starting materials in a ball mill reactor and fervently stirring them. The solution method may be performed by mixing the starting materials in a solvent to obtain a solid electrolyte as a precipitate. In addition, in the case of heat-treatment after mixing, crystals of the solid electrolyte may be more robust and ionic conductivity may be improved. For example, the sulfide solid electrolyte may be prepared by mixing sulfur-containing raw materials and performing heat treatment two or more times. In this case, a sulfide solid electrolyte having high ionic conductivity and robustness may be prepared.

The sulfide solid electrolyte particles according to some embodiments, e.g., may be prepared through a first heat treatment of mixing sulfur-containing raw materials and firing at about 120° C. to about 350° C. and a second heat treatment of mixing the resultant of the first heat treatment and firing the same at about 350° C. to about 800° C. The first heat treatment and the second heat treatment may be performed in an inert gas or nitrogen atmosphere, respectively. The first heat treatment may be performed for about 1 hour to about 10 hours, and the second heat treatment may be performed for about 5 hours to about 20 hours. Small raw materials may be milled through the first heat treatment, and a final solid electrolyte may be synthesized through the second heat treatment. Through such two or more heat treatments, a sulfide solid electrolyte having high ionic conductivity and high performance may be obtained, and such a solid electrolyte may be suitable for mass production. The temperature of the first heat treatment may be, e.g., about 150° C. to about 330° C., or about 200° C. to about 300° C., and the temperature of the second heat treatment may be, e.g., about 380° C. to about 700° C., or about 400° C. to about 600° C.

For example, the sulfide solid electrolyte particles may include argyrodite-type sulfide. The argyrodite-type sulfide solid electrolyte particle may have high ionic conductivity close to the range of about 10-4 to about 10-2 S/cm, which is the ionic conductivity of general liquid electrolytes at room temperature, and may form an intimate bond between the positive electrode active material and the solid electrolyte without causing a decrease in ionic conductivity, and furthermore, an intimate interface between the electrode layer and the solid electrolyte layer. An all-solid-state rechargeable battery including the same may have improved battery performance such as rate capability, coulombic efficiency, and cycle-life characteristics.

For example, the argyrodite-type sulfide solid electrolyte particles may include a compound represented by Chemical Formula 21.

(LiₐM¹_{b}M²_{c})(P_{d}M³ₑ)(S_{f}M⁴_{g})Xₕ [Chemical Formula 21]

In Chemical Formula 21, 4≤a≤8, M¹ is Mg, Cu, Ag, or a combination thereof, 0≤b<0.5, M² is Na, K, or a combination thereof, 0≤c<0.5, M³ is Sₙ, Zn, Si, Sb, Ge, or a combination thereof, 0<d<4, 0≤e<1, M⁴ is O, SOₙ, or a combination thereof, 1.5≤n≤5, 3≤f≤12, 0≤g<2, X is F, Cl, Br, I, or a combination thereof, and 0≤h≤2.

For example, in Chemical Formula 21, a halide element (X) may be necessarily included, and in this case, it may be expressed as 0<h≤2. For example, the M¹ element may be necessarily included in Chemical Formula 21, and in this case, it may be expressed as 0<b<0.5. In Chemical Formula 21, M³ may be understood as an element substituted for P and may be 0<e<1. In Chemical Formula 21, M⁴ is substituted for S and, for example, may be 0<g<2, and f, a ratio of S, may be, for example, 3≤f≤7. When M⁴ is SOₙ, SOₙ may be, for example S₄O₆, S₃O₆, S₂O₃, S₂O₄, S₂O₅, S₂O₆, S₂O₇, S₂O₈, SO₄, or SO₅, and for example, may be SO₄. For example, in Chemical Formula 21, a+b+c+h=7, d+e=1, and f+g+h=6.

As a specific example, the argyrodite-type sulfide solid electrolyte particles may include Li₃PS₄, Li₇P₃S₁₁, Li₇PS₆, Li₆PS₅Cl, Li₆PS₅Br, Li_{5.8}PS_{4.8}Cl_{1.2}, Li_{6.2}PS_{5.2}Br_{0.8}, Li_{5.75}PS_{4.75}Cl_{1.25}, (Li_{5.69}Cu_{0.06})PS_{4.75}Cl_{1.25}, (Li_{5.72}Cu_{0.03}) PS_{4.75}Cl_{1.25}, (Li_{5.69}Cu_{0.06})P(S_{4.70}(SO₄)_{0.05})Cl_{1.25}, (Li_{5.69}Cu_{0.06})P(S_{4.60}(SO₄)_{0.15})Cl_{1.25}, (Li_{5.72}Cu_{0.03})P(S_{4.725}(SO₄)_{0.025})Cl_{1.25}, (Li_{5.72}Na_{0.03})P(S_{4.725}(SO₄)_{0.025})Cl_{1.25}, Li_{5.75}P(S_{4.725}(SO₄)_{0.025})Cl_{1.25}, or a combination thereof, but are not limited thereto.

The argyrodite-type sulfide solid electrolyte may be prepared, e.g., by mixing lithium sulfide and phosphorus sulfide, and optionally lithium halide. Heat treatment may be performed after mixing them. The heat treatment may include, e.g., two or more heat treatment steps. The method of preparing the argyrodite-type sulfide solid electrolyte may include, e.g., a first heat treatment in which raw materials are mixed and fired at about 120° C. to about 350° C., and a second heat treatment in which the resultant of the first heat treatment is mixed again and fired at about 350° C. to about 800° C.

An average particle diameter (D50) of the sulfide solid electrolyte particles may be, e.g., about 0.1 μm to about 5.0 μm or about 0.1 μm to about 3.0 μm, and may be small particles of about 0.1 μm to about 1.9 μm or large particles of about 2.0 μm to about 5.0 μm. The sulfide solid electrolyte particles may be a mixture of small particles having an average particle diameter of about 0.1 μm to about 1.9 μm and large particles having an average particle diameter of about 2.0 μm to about 5.0 μm. The average particle diameter of the sulfide solid electrolyte particles may be measured using an electron microscope image, and e.g., a particle size distribution may be obtained by measuring the size (diameter or length of the long axis) of about 20 particles in a scanning electron microscope image, and D50 may be calculated therefrom.

### Oxide Solid Electrolyte

The oxide solid electrolyte may include, e.g., Li₁₊ₓTi₂₋ₓAl(PO₄)₃(LTAP) (0≤x≤4), Li_{1+x+y}AlₓTi₂₋ₓSi_{y}P_{3-y}O₁₂ (0<x<2, 0≤y<3), BaTiO₃, Pb(Zr,Ti)O₃(PZT), Pb₁₋ₓLaₓZr_{1-y}Ti_{y}O₃ (PLZT) (0≤x<1, 0≤y<1), PB(Mg₃Nb_{2/3})O₃—PbTiO₃ (PMN-PT), HfO₂, SrTiO₃, SnO₂, CeO₂, Na₂O, MgO, NiO, CaO, BaO, ZnO, ZrO₂, Y₂O₃, Al₂O₃, TiO₂, SiO₂, lithium phosphate (Li₃PO₄), lithium titanium phosphate (LiₓTi_{y}(PO₄)₃, 0<x<2, 0<y<3), Li_{1+x+y}(Al, Ga)ₓ(Ti, Ge)₂₋ₓSi_{y}P_{3-y}O₁₂ (0≤x≤1, 0≤y≤1), lithium lanthanum titanate (LiₓLa_{y}TiO₃, 0<x<2, 0<y<3), Li₂O, LiAlO₂, Li₂O—Al₂O₃—SiO₂—P₂O₅—TiO₂—GeO₂ ceramics, Garnet ceramics Li₃₊ₓLa₃M₂O₁₂ (wherein M is Te, Nb, or Zr; x is an integer of 1 to 10), or a mixture thereof.

### Halide Solid Electrolyte

The solid electrolyte layer may further include, e.g., a halide solid electrolyte. The halide solid electrolyte may include a halogen element as a main component, meaning that a ratio of the halide element to all elements constituting the solid electrolyte may be about 50 mol % or more, about 70 mol % or more, about 90 mol % or more, or about 100 mol %. As an example, the halide solid electrolyte may not include sulfur element.

The halide solid electrolyte may include a lithium element, a metal element other than lithium, and a halogen element. The metal element other than lithium may include Al, As, B, Bi, Ca, Cd, Co, Cr, Fe, Ga, Hf, In, Mg, Mn, Ni, Sb, Sc, Sₙ, Ta, Ti, Y, Zn, Zr, or a combination thereof. The halogen element may be F, Cl, Br, I, or a combination thereof, e.g., Cl, Br, or a combination thereof. The halide solid electrolyte may be, e.g., represented by LiₐM₁X₆ (M is Al, As, B, Bi, Ca, Cd, Co, Cr, Fe, Ga, Hf, In, Mg, Mn, Ni, Sb, Sc, Sₙ, Ta, Ti, Y, Zn, Zr, or a combination thereof, X is F, Cl, Br, I, or a combination thereof, and 2≤a≤3). The halide solid electrolyte may include, e.g., Li₂ZrCl₆, Li_{2.7}Y_{0.7}Zr_{0.3}Cl₆, Li_{2.5}Y_{0.5}Zr_{0.5}Cl₆, Li_{2.5}In_{0.5}Zr_{0.5}Cl₆, Li₂In_{0.5}Zr_{0.5}Cl₆, Li₃YBr₆, Li₃YCl₆, Li₃YBr₂Cl₄, Li₃YbCl₆, Li_{2.6}Hf_{0.4}Yb_{0.6}Cl₆, or a combination thereof.

### Binder

The solid electrolyte layer may further include a binder. The binder may include, e.g., a nitrile-butadiene rubber, a hydrogenated nitrile-butadiene rubber, a styrene-butadiene rubber, an acrylated styrene-butadiene rubber, an acrylonitrile-butadiene rubber, an acrylic rubber, a butyl rubber, a fluorine rubber, a natural rubber, polydimethylsiloxane, polyethyleneoxide, polyvinylpyrrolidone, polyvinylpyridine, chlorosulfonatedpolyethylene, polyvinyl alcohol, polytetrafluoroethylene, polyvinylidene fluoride, a polyvinylidene fluoride-hexafluoropropylene copolymer, polyvinylchloride, carboxylated polyvinylchloride, polyvinylfluoride, polyethylene, polypropylene, an ethylene-propylene copolymer, an ethylene-propylene-diene copolymer, polyamideimide, polyimide, poly(meth)acrylate, polyacrylonitrile, polystyrene, polyurethane, a copolymer thereof, or a combination thereof.

The binder may be included in an amount of about 0.1 wt % to about 3 wt %, e.g., about 0.5 wt % to about 2 wt % or about 0.5 wt % to about 1.5 wt %, based on 100 wt % of the solid electrolyte layer. If the binder is included in the above range, the components in the solid electrolyte layer may be well combined without reducing the ionic conductivity of the solid electrolyte, thereby improving durability and reliability of the battery.

### Other Components

The solid electrolyte layer may optionally further include an alkali metal salt, and/or an ionic liquid, and/or a conductive polymer.

The alkali metal salt may be, e.g., a lithium salt. A content of the lithium salt in the solid electrolyte layer may be greater than or equal to about 1 M, e.g., about 1 M to about 4 M. In this case, the lithium salt may improve ionic conductivity by improving lithium ion mobility of the solid electrolyte layer.

The lithium salt may be applied without type limitations, and may include, e.g., LiPF₆, LiBF₄, LiSbF₆, LiAsF₆, LiClO₄, LiAlO₂, LiAlCl₄, LiPO₂F₂, LiCl, LiI, LiSCN, LiN(CN)₂, lithium bis(oxalato)borate (LiBOB), lithium difluoro(oxalato)borate (LiDFOB), lithium difluorobis(oxalato)phosphate (LiDFBP), lithium bis(trifluoromethanesulfonyl)imide (LiTFSI), lithium bis(fluoro) sulfonyl)imide (LiFSI), lithium bis(pentafluoroethanesulfonyl)imide (LiBETI), lithium trifluoromethane sulfonate, lithium tetrafluoroethane sulfonate, or a combination thereof.

For example, the lithium salt may be an imide lithium salt such as LiTFSI, LiFSI, LiBETI, or a combination thereof. The imide lithium salt may maintain or improve ionic conductivity by appropriately maintaining chemical reactivity with the ionic liquid.

The ionic liquid has a melting point below room temperature, so it is in a liquid state at room temperature and refers to a salt or room temperature molten salt composed ofions alone.

The ionic liquid may be a compound including at least one cation selected from a) ammonium, pyrrolidinium, pyridinium, pyrimidinium, imidazolium, piperidinium, pyrazolium, oxazolium, pyridazinium, phosphonium, sulfonium, triazolium, and a mixture thereof, and b) at least one anion selected from BF₄⁻, PF₆⁻, AsF₆⁻, SbF₆⁻, AlCl₄⁻, HSO₄⁻, ClO₄⁻, CH₃SO₃⁻, CF₃CO₂⁻, Cl⁻, Br⁻, I⁻, BF₄⁻, SO₄⁻, CF₃SO₃⁻, (FSO₂)₂N⁻, (C₂F₅SO₂)₂N⁻, (C₂F₅SO₂)(CF₃SO₂)N⁻, and (CF₃SO₂)₂N⁻.

The ionic liquid may be, e.g., one or more selected from N-methyl-N-propylpyrrolidinium bis(trifluoromethanesulfonyl)imide, N-butyl-N-methylpyrrolidium bis(3-trifluoromethylsulfonyl)imide, 1-butyl-3-methylimidazolium bis(trifluoromethylsulfonyl)amide, and 1-ethyl-3-methylimidazolium bis(trifluoromethylsulfonyl)amide.

A weight ratio of the solid electrolyte and the ionic liquid in the solid electrolyte layer may be about 0.1:99.9 to about 90:10, e.g., about 10:90 to about 90:10, about 20:80 to about 90:10, about 30:70 to about 90:10, about 40:60 to about 90:10, or about 50:50 to about 90:10. The solid electrolyte layer satisfying the above ranges may maintain or improve ionic conductivity by improving the electrochemical contact area with the electrode. Accordingly, the energy density, discharge capacity, rate capability, etc. of the all-solid-state rechargeable battery may be improved.

The rechargeable lithium battery according to some embodiments may be applied to automobiles, mobile phones, and/or various types of electrical devices, but the present disclosure is not limited thereto.

The following Examples and Comparative Examples are provided in order to highlight characteristics of one or more embodiments, but it will be understood that the Examples and Comparative Examples are not to be construed as limiting the scope of the embodiments, nor are the Comparative Examples to be construed as being outside the scope of the embodiments. Further, it will be understood that the embodiments are not limited to the particular details described in the Examples and Comparative Examples.

### Example 1

### (1) Manufacture of Acrylate Resin Layer

Two acrylate resin layers were prepared in the following method to use one as a first acrylate resin layer, while using the other as a second acrylate resin layer.

In a four-necked flask equipped with a stirring blade, a thermometer, a nitrogen gas-introducing tube, and a cooler, a monomer mixture of 50 parts by weight of 2-ethylhexylacrylate, 10 parts by weight of 4-hydroxybutylacrylate, and 40 parts by weight of isobornylacrylate was added. In addition, based on 100 parts by weight of the monomer mixture, 0.1 parts by weight of 2,2′-azobisisobutyronitrile as a polymerization initiator along with 85 parts by weight of ethyl acetate and 15 parts by weight of toluene as a solvent was added thereto, and after substituting nitrogen gas with nitrogen, a polymerization reaction was conducted for 8 hour, while maintaining the reaction solution in the flask at 55° C., to prepare an acrylate copolymer (Mw=1,300,000 g/mol, Mw/Mn=1.7) composition.

The composition for an acrylate resin layer included, based on 100 parts by weight of a solid of the acrylate copolymer composition, 0.1 parts by weight of an isocyanate crosslinking agent (a trimethylolpropane/xylylene diisocyanate adduct, Tradename: Takenate D110N, Manufacturer: Mitsui Chemicals, Inc.), 0.1 parts by weight of a silane coupling agent (KBM-403, Manufacturer: Shin-Etsu Chemical Co., Ltd.), 1.5 parts by weight of polymer microspheres (Tradename: Expancel 920DU20, Manufacturer: Nouron), and 0.05 parts by weight of silica (Aerosil-200, Manufacturer: EVONIK).

Subsequently, the composition for the acrylate resin layer was applied on one surface of a polyethyleneterephthalate film (a separator film: SKC Haas, MRF38, Mitsubishi Chemical Corp.) treated with a silicon release agent, then dried at 135° C. for 2 minutes, and then dried at 150° C. for 3 minutes to form an acrylate resin layer (a thickness: 125 μm).

During the drying process, the polymer microspheres were expanded, making the acrylate resin layer into a foam form.

### (2) Manufacture of Elastic Sheet

The first acrylate resin layer was laminated on one surface of a polyurethane film (TPU film, a thickness: 50 μm, Manufacturer: Ventwin Co., Ltd.) with a melt index (MI) of about 8.8 g/10 min, which was measured at 210° C. with 2.16 Kg, while the second acrylate resin layer was laminated on the other surface of the polyurethane film, manufacturing an elastic sheet.

### (3) Manufacture of Positive Electrode

85 wt % of a LiNi_{0.8}Co_{0.15}Mn_{0.05}O₂ positive electrode active material, 13.5 wt % of a lithium argyrodite-type solid electrolyte Li₆PS₅Cl, 1.0 wt % of a polyvinylidene fluoride binder, and 0.5 wt % of a carbon nanotube conductive material were mixed in an N-methyl pyrrolidone solvent to prepare a positive electrode composition. The prepared positive electrode composition was coated on an aluminum positive electrode current collector using a bar coater, dried, and rolled to manufacture a positive electrode.

### (4) Manufacture of Solid Electrolyte Layer

An acrylic binder (SX-A334, Zeon Chemicals L.P.) was dissolved in an isobutyryl isobutyrate (IBIB) solvent to prepare a binder solution, and an argyrodite-type solid electrolyte Li₆PS₅Cl (D50-3 μm) was added thereto, and then stirred with a Thinky mixer to secure appropriate viscosity. Then, 2 mm zirconia balls were added to the resultant mixture, and then stirred again to prepare a slurry. In the prepared slurry, a content of the solid electrolyte was 98.5 wt % and a content of the binder was 1.5 wt %, based on 100 wt % of the slurry.

The slurry was bar-coated on a release polyethylene film and dried at room temperature (25° C.). The release polyethylene film was removed to obtain a solid electrolyte layer.

### (5) Manufacture of Negative Electrode

Carbon black with a primary particle diameter (D50) of about 30 nm and silver (Ag) with an average particle diameter (D50) of about 60 nm were mixed at a weight ratio of 3:1, and 0.25 g of this mixture was added to 2 g of N-methyl pyrrolidone solution including 7 wt % of polyvinylidene fluoride binder and mixed to prepare a negative electrode active material layer composition. The negative electrode active material layer composition was coated on a nickel foil current collector using a bar coater and dried in vacuum to manufacture a negative electrode.

### (6) Manufacture of All-Solid-state Battery Cell

The manufactured positive electrode, solid electrolyte layer, and negative electrode were sequentially stacked, and the manufactured elastic sheet was stacked on the negative electrode. Subsequently, the negative electrode, the solid electrolyte layer, and the positive electrode were sequentially stacked again thereon to manufacture an assembly of positive electrode/solid electrolyte/negative electrode/elastic sheet/negative electrode/solid electrolyte/positive electrode in order.

The assembly was inserted in a laminate film and hydrostatically pressed under a pressure of 500 MPa at 80° C. to manufacture an all-solid-state battery cell. In the pressurized state, the positive electrode active material layer had a thickness of about 100 μm, the negative electrode coating layer had a thickness of about 7 μm, the solid electrolyte layer had a thickness of about 60 μm, and the elastic sheet had a thickness of about 120 μm.

### Example 2

The elastic sheet and the all-solid-state battery cell were manufactured in the same manner as in Example 1, except that the mixing ratio of the monomer mixture and the content of the polymer microsphere were changed. Specifically, the monomer mixture was prepared by using 45 parts by weight of 2-ethylhexylacrylate, 10 parts by weight of 4-hydroxybutylacrylate, and 45 parts by weight of isobornylacrylate. In addition, in preparing the composition for an acrylate resin layer, 1.3 parts by weight of the polymer microspheres was used.

### Example 3

The elastic sheet and the all-solid-state battery cell were manufactured in the same manner as in Example 1, except that the mixing ratio of the monomer mixture and the content of the polymer microsphere were changed. Specifically, the monomer mixture was prepared by using 45 parts by weight of 2-ethylhexylacrylate, 10 parts by weight of 4-hydroxybutylacrylate, and 45 parts by weight of isobornylacrylate. In addition, in preparing the composition for an acrylate resin layer, 1.7 parts by weight of the polymer microspheres was used.

### Example 4

An elastic sheet and an all-solid-state battery cell were manufactured in the same manner as in Example 1, except that each dense acrylate resin layer (a BHF film, a thickness: 100 μm, Manufacturer: Youngwoo Co., Ltd.) was used as a first acrylate resin layer and a second acrylate resin layer.

### Comparative Example 1

An all-solid-state battery cell was manufactured in the same manner as in Example 1, except that a 300 μm-thick TEFLON (tetrafluoroethylene) sheet (Tradename: Hyper Sheet, Manufacturer: GORE) was used as the elastic sheet.

### Comparative Example 2

An all-solid-state battery cell was manufactured in the same manner as in Example 1, except that a 300 μm-thick silicone pad (a silicone rubber sheet, Manufacturer: ASONE Corp.) was used as the elastic sheet.

### Comparative Example 3

An all-solid-state battery cell was manufactured in the same manner as in Example 1, except that a 300 μm-thick urethane foam (Tradename: M1, Manufacturer: Mainelecom Co., Ltd.) was used the elastic sheet.

### Comparative Example 4

An all-solid-state battery cell was manufactured in the same manner as in Example 1, except that a 300 μm-thick urethane foam (Tradename: M2, Manufacturer: Mainelecom Co., Ltd.) was used as the elastic sheet.

### Comparative Example 5

An all-solid-state battery cell was manufactured in the same manner as in Example 1, except that a 300 μm-thick urethane was used as the elastic sheet. Herein, the urethane foam was manufactured by mixing polyethylene diol ((Mw=2,000 g/mol), TDI (toluene disocyanate)), ethylenediamine as a chain extender, and silica with nitrogen, coating the mixture to be 300 μm thick on a polyethylene terephthalate (PET) film, and curing it at 120° C. for 3 minutes.

### Comparative Example 6

An all-solid-state battery cell was manufactured in the same manner as in Example 1, except that a 300 μm-thick acryl foam (Tradename: BLF, Manufacturer: Youngwoo Co., Ltd.) was used as the elastic sheet.

### Evaluation Example 1: Evaluation of Loss Coefficient (tan δ) and Storage Modulus of Elastic Sheet

The elastic sheets of Examples 1 to 4 and Comparative Examples 1 to 6 were evaluated with respect to a loss coefficient (tan δ) and a storage modulus, and the results are shown in Tables 1 and 2.

Each of the elastic sheets was cut into a specimen with a size of width*length=0.5 cm*3 cm, the elastic sheet specimen was placed between two jigs, and then tightened into 15 N by a screw to fix the elastic sheet. Herein, a distance between the two jigs was set to 11.5 mm.

The elastic sheet fixed between the two jigs was heated from −40° C. to 80° C. at 5° C./min, while simultaneously, applied with a stain of 0.15%, and then measured with respect to dynamic viscoelasticity under conditions of each temperature (25° C. or 45° C.) and frequency (100 rad/s, 1 rad/s, or 0.1 rad/s) by using DMA-Q800 (TA Instruments). Herein, a loss modulus and a storage modulus were evaluated, which were used to calculate a ratio of loss modulus/storage modulus as a loss coefficient (tan δ).

### Evaluation Example 2: Evaluation of Compressive Strength, Stress Relief Rate, and Recovery Rate of Elastic Sheet

Each of the elastic sheets of Examples 1 to 4 and Comparative Examples 1 to 6 was cut into a size of width*length=2 cm*2 cm to prepare a specimen, and the specimen, while compressed at 0.6 mm/min (10 μm/sec) by using a compression tester with a spherical jig with a diameter of 10 mm, was evaluated with respect to compressive strength, a stress relief rate, and a recovery rate. The results are shown in Tables 1 and 2.

### (1) Compressive Strength

The elastic sheet specimen, at a point of being compressed to 60% of an initial thickness, was measured with respect to CFD 40% according to ASTM D3574 by using UTM (Manufacturer: Shimadzu Scientific Korea Corp.).

### (2) Stress Relief Rate

At a point of being compressed to 40% of an initial thickness under 2.5 Kgf, an initial stress of the elastic sheet specimen was measured. In addition, after 60 seconds from the point of being compressed to 40% of the initial thickness, stress of the elastic sheet specimen was measured. Herein, the stress at each point was measured by using TA (Texture Analyzer, Manufacturer: Stable Micro Systems).

A stress relief rate was calculated according to Equation 3.

$$Stress relief rate = 100 * ( Stress after 60 seconds when compressed to 40 \% of initial thickness ) / ( Initial stress when compressed to 40 \% of initial thickness ) \qquad [ Equation 3 ]$$

### (3) Recovery Rate

Each elastic sheet specimen was measured with respect to initial stress at a point of being compressed under 2.5 Kgf to 60% of its initial thickness. In addition, stress of the elastic sheet specimen was measured at a point when the elastic sheet specimen was compressed to 40% of the initial thickness recovered 60% of the initial thickness. Herein, the stress at each point was measured by using TA (Texture Analyzer, Manufacturer: Stable Micro Systems).

A recovery rate was calculated according to Equation 4.

$$Recovery rate = 100 * ( Stress upon restoration to 60 \% of the initial thickness after compression to 40 \% of the initial thickness ) / ( Initial stress after compression to 60 \% of the initial thickness ) \qquad [ Equation 4 ]$$

### Evaluation Example 3: Evaluation of Cycle-life of All-solid-state Battery Cell

Each of the all-solid-state battery cells of Examples 1 to 4 and Comparative Examples 1 to 6 was evaluated with respect to cycle-life in the following method. The results are shown in Tables 1 and 2.

The all-solid-state battery cells were charged at a constant current of 0.1 C to an upper limit voltage of 4.25 V and discharged to a cut-off voltage of 2.5 V at 0.1 C at 45° C. for initial charge and discharge.

After the initial charge and discharge, the all-solid-state battery cells were 300 cycles or more repeatedly charged and discharged at 0.3 C within a voltage range of 2.5 V to 4.25 V at 45° C. to evaluate the number of cycles when discharge capacity retention was reduced to 80% of initial discharge capacity.

TABLE 1

| | | | Ex. 1 | Ex. 2 | Ex. 3 | Ex. 4 |
|---|---|---|---|---|---|---|
| Structure | | | 3Layer | 3Layer | 3Layer | 3Layer |
| Material | | | acryl/ | acryl/ | acryl/ | acryl/ |
| | | | urethane/ | urethane/ | urethane/ | urethane/ |
| | | | acryl | acryl | acryl | acryl |
| Compressive | | | 2 | 2 | 2 | 2 |
| strength@CFD40% (MPa) | | | | | | |
| Stress relief rate (%) | | | 14 | 13 | 12 | 11 |
| Recovery rate (%) | | | 65.6 | 67.4 | 69.5 | 70.1 |
| 25° C. | 100 rad/s | Storage | 5.9 | 5.4 | 5.1 | 4.5 |
| | | modulus (MPa) | | | | |
| | | Tanδₐ | 0.863 | 0.75 | 0.75 | 0.73 |
| | 1 rad/s | Storage | 1.17 | 1.2 | 1.05 | 1.01 |
| | | modulus (MPa) | | | | |
| | | Tanδ_{b} | 0.573 | 0.51 | 0.45 | 0.42 |
| | 100 rad/s/ | Tanδₐ/Tanδ_{b} | 1.51 | 1.47 | 1.67 | 1.74 |
| | 1 rad/s | | | | | |
| 45° C. | 0.1 rad/s | Storage | 0.5 | 0.48 | 0.49 | 0.42 |
| | | modulus (MPa) | | | | |
| | | Tanδ_{c} | 0.182 | 0.17 | 0.16 | 0.14 |
| | 1 rad/s | Storage | 0.64 | 0.62 | 0.5 | 0.51 |
| | | modulus (MPa) | | | | |
| | | tanδ_{d} | 0.26 | 0.23 | 0.2 | 0.21 |
| | 100 rad/s/ | Tanδ_{c}/Tanδ_{d} | 0.7 | 0.74 | 0.8 | 0.67 |
| | 1 rad/s | | | | | |

| | | | | |
|---|---|---|---|---|
| Cycle-life (cycle number) | >300 | >300 | >300 | >300 |

TABLE 2

| | | | Comp. | Comp. | Comp. | Comp. | Comp. | Comp. |
|---|---|---|---|---|---|---|---|---|
| | | | Ex. 1 | Ex. 2 | Ex. 3 | Ex. 4 | Ex. 5 | Ex. 6 |
| Structure | | | 1 layer | 1 layer | 1 layer | 1 layer | 1 layer | 1 layer |
| Material | | | TEFLON | silicone | urethane | urethane | urethane | acryl |
| | | | (tetrafluoroethylene) | | | | | |
| Compressive strength | | | 2 | 2 | 2 | 2 | 2 | 2 |
| @CFD40% (MPa) | | | | | | | | |
| Stress relief rate (%) | | | 10 | 0.4 | 8 | 13.9 | 8.1 | 15.1 |
| Recovery rate (%) | | | 79.7 | 100 | 80.8 | 77.1 | 82.8 | 63.2 |
| 25° C. | 100 rad/s | Storage | 1.58 | 0.72 | 0.829 | 0.978 | 0.78 | 1.87 |
| | | modulus (MPa) | | | | | | |
| | | Tanδₐ | 0.426 | 0.111 | 0.555 | 0.298 | 0.086 | 0.697 |
| | 1 rad/s | Storage | 1.28 | 0.62 | 0.788 | 0.68 | 0.636 | 0.45 |
| | | modulus (MPa) | | | | | | |
| | | Tanδ_{b} | 0.173 | 0.076 | 1.838 | 0.308 | 0.064 | 0.504 |
| | 100 rad/s/ | Tanδₐ/Tanδ_{b} | 2.46 | 1.46 | 0.30 | 0.97 | 1.34 | 1.38 |
| | 1 rad/s | | | | | | | |
| 45° C. | 0.1 rad/s | Storage | 0.65 | 0.58 | 0.635 | 0.56 | 0.53 | 0.49 |
| | | modulus (MPa) | | | | | | |
| | | Tanδ_{c} | 0.13 | 0.036 | 0.1 | 0.24 | 0.043 | 0.23 |
| | 1 rad/s | Storage | 0.75 | 0.6 | 0.725 | 0.61 | 0.58 | 0.63 |
| | | modulus (MPa) | | | | | | |
| | | tanδ_{d} | 0.15 | 0.041 | 0.214 | 0.252 | 0.045 | 0.32 |
| | 100 rad/s/ | Tanδ_{c}/Tanδ_{d} | 0.87 | 0.88 | 0.47 | 0.95 | 0.96 | 0.72 |
| | 1 rad/s | | | | | | | |

| | | | | | | |
|---|---|---|---|---|---|---|
| Cell cycle-life (cyc.) | 110 | 54 | 250 | 220 | 260 | 205 |
| at retention 80% | | | | | | |

### (Summary)

Considering Tables 1 and 2, the elastic sheets with a three-layer structure (examples) in which a polyurethane film was disposed between two (meth)acrylate resin layers, compared with the elastic sheet with one layer structure consisting of TEFLON (tetrafluoroethylene), silicone, urethane, or acryl alone (the comparative examples), had a loss coefficient (tan δ) with an appropriate range under each condition and harmoniously expressed compressive strength, a stress relief rate, and a recovery rate. Furthermore, the elastic sheets having the aforementioned characteristics of the examples improved cycle-life characteristics of all-solid-state batteries.

By way of summation and review, rechargeable lithium batteries are lithium ion batteries that may include an electrolyte solution including a potentially flammable organic solvent, thereby reducing safety, e.g., due to a potential explosion or fire in response to a collision or a penetration. Accordingly, an all-solid-state battery using a solid electrolyte instead of an electrolyte solution is desirable.

Exemplary embodiments provide an elastic sheet for an all-solid-state battery that balances stress relief properties and restoration properties. Some embodiments provide an all-solid-state battery including the elastic sheet.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. An elastic sheet for an all-solid-state battery, the elastic sheet comprising
a polyurethane film;
a first (meth)acrylate resin layer on a first surface of the polyurethane film; and
a second (meth)acrylate resin layer on a second surface of the polyurethane film.

2. The elastic sheet as claimed in claim 1, wherein the polyurethane film has a melt index of about 5 g/10 min to about 12 g/10 min measured at a temperature of 210° C. and at 2.16 Kg.

3. The elastic sheet as claimed in claim 1, wherein the first (meth)acrylate resin layer and the second (meth)acrylate resin layer are each in a form of foam.

4. The elastic sheet as claimed in claim 1, wherein the elastic sheet has a value of about 1.4 to about 2, calculated according to Equation 1:
$$tan {δ}_{a} / tan {δ}_{b} \qquad [ Equation 1 ]$$
wherein, in Equation 1,
tan δₐ is a loss coefficient (tan δ) when dynamic viscoelasticity is measured at a temperature of 25° C. and a frequency of 100 rad/s,
tan δ_{b} is a loss coefficient (tan δ) when dynamic viscoelasticity is measured at a temperature of 25° C. and a frequency of 1 rad/s, and
in each of the above conditions, the loss coefficient (tan δ) is calculated as loss modulus/storage modulus.

5. The elastic sheet as claimed in claim 4, wherein the elastic sheet has a tan δₐ value of about 0.7 to about 1.

6. The elastic sheet as claimed in claim 3, wherein the elastic sheet has a tan δ_{b} value of about 0.4 to about 0.7.

7. The elastic sheet as claimed in claim 3, wherein the elastic sheet has a storage modulus of about 0.9 MPa to about 1.5 MPa when dynamic viscoelasticity is measured at a temperature of 25° C. and a frequency of 1 rad/s.

8. The elastic sheet as claimed in claim 1, wherein the elastic sheet has a value of about 0.6 to about 1, calculated according to Equation 2:
$$tan {δ}_{c} / tan {δ}_{d} \qquad [ Equation 2 ]$$
wherein, in Equation 2,
tan δ_{c} is a loss coefficient (tan δ) when dynamic viscoelasticity is measured at a temperature of 45° C. and a frequency of 0.1 rad/s,
tan δₐ is a loss coefficient (tan δ) when dynamic viscoelasticity is measured at a temperature of 45° C. and a frequency of 1 rad/s, and
in each of the above conditions, the loss coefficient (tan δ) is calculated as loss modulus/storage modulus.

9. The elastic sheet as claimed in claim 8, wherein the elastic sheet has a tan δc value of about 0.14 to about 0.2.

10. The elastic sheet as claimed in claim 8, wherein the elastic sheet has a tan δₐ value of about 0.2 to about 0.3.

11. The elastic sheet as claimed in claim 8, wherein the elastic sheet has a storage modulus of about 0.4 MPa to about 0.6 MPa, when dynamic viscoelasticity is measured at a temperature of 45° C. and a frequency of 0.1 rad/s.

12. The elastic sheet as claimed in claim 1, wherein the elastic sheet has a compression force deflection that is a compressive strength of 40% to 50% of about 1 MPa to about 5 MPa, measured according to ASTM D3574 at a point where it is compressed to 50% to 60% of its initial thickness.

13. The elastic sheet as claimed in claim 1, wherein the elastic sheet has a stress relief rate of about 11% to about 14% according to Equation 3:
$$Stress relief rate = 100 * ( Stress after 60 seconds when compressed to 40 \% of initial thickness ) / ( Initial stress when compressed to 40 \% of initial thickness ) . \qquad [ Equation 3 ]$$

14. The elastic sheet as claimed in claim 1, wherein the elastic sheet has a recovery rate of about 65% to about 75% according to Equation 4:
$$Recovery rate = 100 * ( Stress upon restoration to 60 \% of the initial thickness after compression to 40 \% of the initial thickness ) / ( Initial stress after compression to 60 \% of the initial thickness ) . \qquad [ Equation 4 ]$$

15. An all-solid-state battery, comprising:
the elastic sheet as claimed in claim 1; and
an electrode assembly, the electrode assembly including a positive electrode, a negative electrode, and a solid electrolyte layer between the positive electrode and the negative electrode, and the elastic sheet being outside at least one of the positive electrode and the negative electrode.
